(19) United States
(12) Patent Application Publication
(10) Pub. No.: US 2012/0301814 A1
(43) Pub. Date: Nov. 29, 2012

(54) ELECTRICALLY DRIVEN AIRCRAFT

(76) Inventors: Paul Beasley, Abingdon (GB); Oliver Heid, Erlangen (DE); Timothy Hughes, Erlangen (DE)

(21) Appl. No.: 13/576,108

(22) PCT Filed: Jan. 28, 2011
(86) PCT No.: PCT/EP2011/051233

§ 371 Date: Jul. 30, 2012

(30) Foreign Application Priority Data
Jan. 29, 2010 (DE) 10 2010 006 153.0

(51) Int. Cl. B64D 27/24; H01M 8/22

(52) U.S. Cl. 429/504

(57) ABSTRACT

An electrically driven aircraft may include a tank for NH3 in order to provide NH3, an energy source, which generates electric energy using and converting NH3, an electrically driven propulsion system that ensures the propulsion of the aircraft, and an energy distribution system that supplies the generated electric energy to the propulsion system.

### CROSS-REFERENCE TO RELATED APPLICATIONS

This application is a U.S. National Stage Application of International Application No. PCT/EP2011/051233 filed Jan. 28, 2011, which designates the United States of America, and claims priority to DE Patent Application No. 10 2010 006 153.0 filed Jan. 29, 2010. The contents of which are hereby incorporated by reference in their entirety.

### TECHNICAL FIELD

This disclosure relates to an aircraft which is equipped with an electrical propulsion system.

### BACKGROUND

Aircraft having propulsion systems or power plants that are driven by means of combustion engines or gas turbines are widely established in the aviation field.

Furthermore there exist considerations for driving the propulsion systems or power plants of an airplane or a helicopter with the aid of electric motors; cf. U.S. Pat. No. 2,462,201 and U.S. Pat. No. 4,955,560.

Similarly, there exist considerations for equipping an aircraft with a hydrogen fuel cell; cf. U.S. Pat. No. 6,568,633 or U.S. Pat. No. 6,854,688. U.S. Pat. No. 4,709,882 discloses a helicopter having a lithium/peroxide fuel cell.

### SUMMARY

In one embodiment, an electrically driven aircraft may comprise: a tank for NH₃ for providing NH₃, an energy source which generates electrical energy by using and converting NH₃, an electrically driven propulsion system which is responsible for powering the aircraft, and an energy distribution system which provides the generated electrical energy to the propulsion system.

In a further embodiment, the aircraft additionally has at least one further electrical system which obtains the electrical energy necessary for its operation via the energy distribution system from the electrical energy generated by the energy source. In a further embodiment, the aircraft additionally includes a storage device which is connected to the energy distribution system and serves for storing surplus electrical energy that has been generated. In a further embodiment, the energy source, which generates electrical energy by using and converting NH₃, is an NH₃-powered fuel cell system. In a further embodiment, the NH₃-powered fuel cell system includes an NH₃ fuel cell which generates electrical energy by directly using NH₃ as fuel. In a further embodiment, the NH₃-powered fuel cell system includes an ammonia separator for generating H₂ and N₂ and, connected downstream thereof, a hydrogen fuel cell which generates electrical energy by using H₂ as fuel. In a further embodiment, a molecular sieve is disposed between the ammonia separator and the hydrogen fuel cell for the purpose of removing contaminants due to residual NH₃ from the H₂ supplied to the hydrogen fuel cell. In a further embodiment, the energy source comprises an internal combustion engine fed from the NH₃ tank and an electric generator driven by the internal combustion engine. In a further embodiment, an exhaust gas treatment device is provided which cleans the exhaust gas produced by the internal combustion engine of nitrogen oxides before the exhaust gas is discharged into the atmosphere. In a further embodiment, the aircraft is embodied as an airplane or as a helicopter. In a further embodiment, the tank can be connected to the atmosphere by way of a thermal coupling for the purpose of cooling the tank and the NH₃ contained in the tank, wherein heat from the tank can be discharged to the atmosphere by way of the thermal coupling. In a further embodiment, a controller is provided which is embodied for thermally coupling the tank to the atmosphere if the atmospheric temperature in the vicinity of the aircraft falls below a specific threshold value. In a further embodiment, a controller is embodied for interrupting the thermal coupling if the atmospheric temperature in the vicinity of the aircraft rises above a specific threshold value.

### BRIEF DESCRIPTION OF THE DRAWINGS

Example embodiments will be explained in more detail below with reference to figures, in which:

FIG. 1 shows a schematic representation of an NH3-powered propulsion system for an aircraft, according to one embodiment;

FIG. 2 shows a schematic representation of a further NH3-powered propulsion system for an aircraft, according to one embodiment;

FIG. 3 shows a schematic representation of a further NH3-powered propulsion system for an aircraft, according to one embodiment;

FIG. 4 shows a schematic representation of a propulsion system for an aircraft on the basis of a hydrocarbon-based fuel, according to one embodiment;

FIG. 5 shows a cooling device for cooling the ammonia tank in a schematic view, according to one embodiment; and

FIGS. 6A-6B show a characteristic curve of the outside temperature as well as the status of the thermal coupling between ammonia tank and atmosphere as a function of time.

### DETAILED DESCRIPTION

Some embodiments provide an aircraft which is driven by means of an alternative energy source.

In some embodiments, an aircraft is electrically driven and comprises:
a tank for NH3 for providing NH3,
an energy source which generates electrical energy by using and converting NH3,
an electrically driven propulsion system which is responsible for the propulsion of the aircraft, and
an energy distribution system which provides the generated electrical energy to the propulsion system.

The use of ammonia gas as a starting basis for the energy source which provides the electrical energy for propulsion may proves advantageous because ammonia is an easily liquefiable gas and consequently can be easily stored and transported. For example, the tank can be pressurized and/or cooled in order to store the ammonia gas in liquid form.

In one embodiment the aircraft can additionally have at least one further electrical system which obtains the electrical energy necessary for its operation via the energy distribution system from the electrical energy generated by the energy source.

The energy distribution system therefore provides the electrical energy not only to the aircraft's propulsion system, which is responsible for the powering or propulsion of the aircraft, e.g. the power plants, but also to at least one further electrical system which, though used during a flight, does not contribute directly to the powering and propulsion of the aircraft.

In one embodiment the aircraft can additionally comprise a storage device connected to the energy distribution system for the purpose of storing surplus electrical energy that has been generated. This means that the electrical energy which is provided by the energy source and which is not consumed by the electrically driven propulsion system or by further electrical systems is stored in the storage device and when necessary during the operation of the aircraft can be fed back into the energy distribution system again and from there provided to the propulsion system or another electrical system. A control device can control the supplying of surplus generated energy to the storage device in phases in which more electrical energy is generated than is required during the operation of the aircraft—such as e.g. during flight phases—and control the connection of the stored energy from the storage device in phases in which less electrical energy is generated than is required during the operation of the aircraft—such as e.g. during takeoff and landing.

The storage device can be e.g. a short-term storage buffer for electrical energy. The storage device can comprise e.g. a rechargeable battery, a capacitor, a disk flywheel or another energy storage device. This enables a temporary failure of the electrical energy source to be bridged, for example.

In one embodiment the energy source, which generates electrical energy by using and converting NH₃, can include an NH₃-powered fuel cell system. A fuel cell is a galvanic cell which converts the energy of a chemical reaction between a continuously supplied fuel and an oxidizing agent, in most cases oxygen, into electrical energy.

In this arrangement the NH₃-powered fuel cell system includes an NH₃ fuel cell which generates electrical energy through direct use of NH₃ as fuel. In this case the typical chemical reaction is: 4 NH₃+3 O₂->N₂+6 H₂O.

Alternatively and/or in addition the NH₃-powered fuel cell system can include an ammonia separator for generating H₂ and, connected downstream thereof, a hydrogen fuel cell which generates electrical energy by using the H₂ provided by the ammonia separator as fuel. The typical chemical reaction for this is: 2 H₂+O₂->2 H₂O.

The hydrogen can be produced in a reformer e.g. by thermally splitting the ammonia into its elements. The typical chemical reaction for this is: 2 NH₃->N₂+3 H₂. Typically forming part of such a reformer is a temperature-resistant ceramic which is coated with a catalyst (e.g. platinum, palladium, etc.).

A molecular sieve can be disposed between the ammonia separator and the hydrogen fuel cell in order to remove contaminants due to residual NH₃ from the H₂ supplied to the hydrogen fuel cell.

It is not, however, absolutely essential to interpose the molecular sieve, since, depending on the purity of the hydrogen provided by the ammonia separator or, as the case may be, the sensitivity of the hydrogen fuel cell to contaminants, the generated hydrogen can be supplied directly to the hydrogen fuel cell.

In another embodiment the energy source can include an internal combustion engine fed from the NH₃ tank and an electric generator driven by the internal combustion engine. The internal combustion engine can be an internal combustion engine operating with NH₃ as fuel. It is, however, also conceivable to split up the NH₃ fed from the NH₃ tank into N₂ and H₂ first and then to use the H₂ as fuel for the internal combustion engine. A combustion engine or gas turbine, for example, can be used as the internal combustion engine.

In this case an exhaust gas treatment device can be provided which cleans the exhaust gas produced by the internal combustion engine of nitrogen oxides before it is discharged into the atmosphere. This can serve to avoid potentially environmentally harmful nitrogen oxides being released.

Another variant of the propulsion system of an electrically driven aircraft comprises:
a tank for a hydrocarbon-based fuel such as e.g. gasoline, diesel or kerosene,
an internal combustion engine operating with said fuel,
an electric generator which is driven by the internal combustion engine and by means of which electrical energy can be generated,
an electrically driven propulsion system which is responsible for powering the aircraft, and
an energy distribution system which provides the generated electrical energy to the propulsion system.

The atmosphere can be used, at least temporarily, i.e. while the aircraft is in the air and the outside temperature in the vicinity of the aircraft is below a specific value, for cooling the tank or, more specifically, the ammonia. In this case use is made of the fact that the temperature falls as the height above sea level increases, so that when the aircraft reaches a certain altitude the prevailing outside temperature is sufficiently low to cool down the ammonia contained in the tank to a temperature at which the ammonia is present in liquid form. This may provide that, in particular while the aircraft is flying at an appropriate altitude, a comparatively small amount of energy, or in the ideal case even no energy at all, is consumed in order to cool the ammonia. Since the proportion of energy required to be consumed for cooling purposes is quite high, a significant increase in efficiency can be achieved by means of this measure.

For this purpose a controller is provided which is embodied for thermally coupling the tank to the atmosphere when the atmospheric temperature in the vicinity of the aircraft falls below a specific threshold value S1.

The controller is furthermore embodied for interrupting the thermal coupling if the atmospheric temperature in the vicinity of the aircraft rises above a specific threshold value.

The aircraft can be embodied for example as an airplane or as a helicopter.

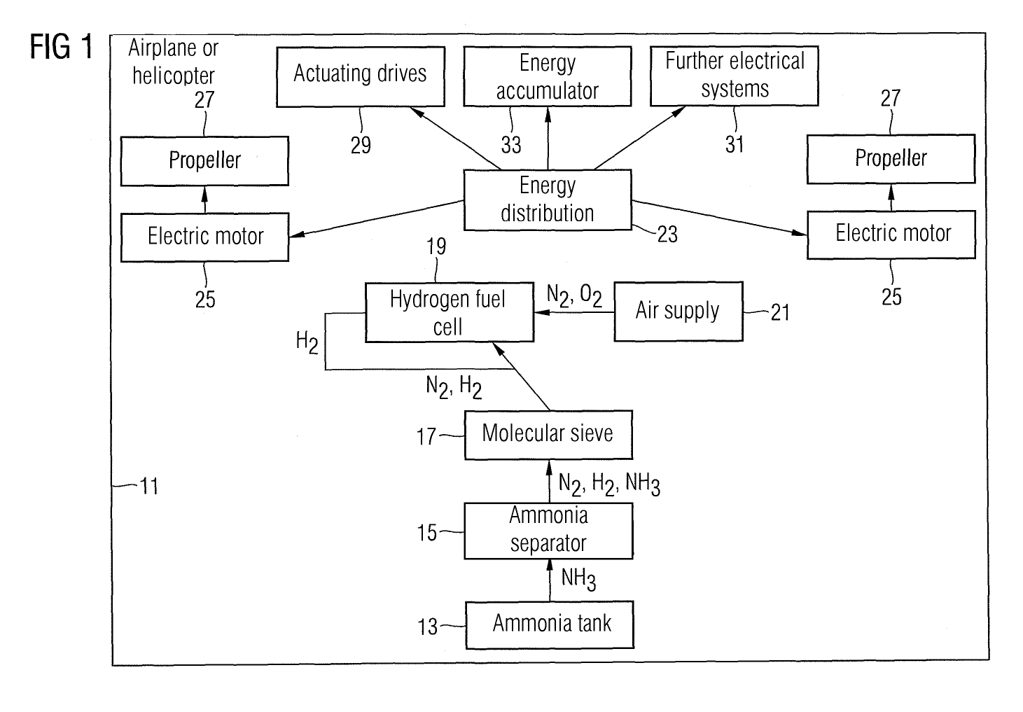

FIG. 1 shows an aircraft having an NH₃-powered propulsion system, according to one embodiment.

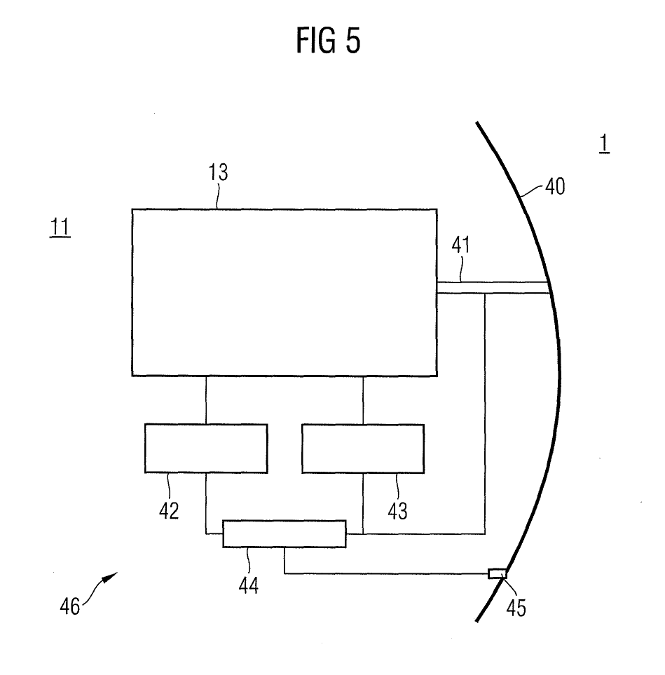

The aircraft 11, e.g. an airplane or a helicopter, includes a fuel tank 13 containing liquid ammonia. The fuel tank 13 can be e.g. pressurized and/or cooled in order to maintain the ammonia in a liquid state. A possible means of cooling the tank 13 is illustrated in FIG. 5. The ammonia is then routed to a heat exchanger and from there fed to an ammonia separator 15. This reformer generates hydrogen and nitrogen from the ammonia, the gas mixture potentially still containing slight traces of contaminants due to ammonia. The gas mixture is then passed through a molecular sieve 17 in order to remove residual traces of ammonia. This is important in particular when fuel cells are used in which ammonia leads to a degradation of their functionality.

The hydrogen contained in the gas mixture is supplied to a hydrogen fuel cell 19. Examples of fuel cells of this type include what are termed polymer electrolyte membrane fuel cells (PEMFCs), phosphoric acid fuel cells (PAFCs), solid oxide fuel cells (SOFCs) or protonic ceramic fuel cells (PCFCs), though suitable fuel cells are not limited to these.

Air can be supplied to the fuel cell 19 via an air supply 21, by means of a compressor for example. Optionally the air can be cleaned before being supplied to the fuel cell 19. For example, the carbon dioxide contained in the air can be removed before the air is supplied to the fuel cell 19 if the type of fuel cell 19 would otherwise be adversely affected in its mode of operation by carbon dioxide.

The oxygen contained in the air serves as an oxidizing agent for the fuel cell 19. The fuel cell 19 produces electricity and exhaust gases, residual hydrogen potentially being contained in the exhaust gases. The hydrogen contained in the exhaust gases can be recovered in a closed circuit and resupplied to the fuel cell 19.

The electricity is supplied to an intelligent energy distribution system 23 from where the electrical energy is used to supply systems in the aircraft with electrical energy.

The aircraft's drive system which is responsible for the propulsion can comprise one or more electric motors 25 which are connected to power plants 27 and so set propellers or similar drive elements in motion.

The electrical energy can also be used to supply electrical energy to other electrical systems such as e.g. actuating drives 29 or other systems 31 used in the aircraft.

Excess electrical energy can be temporarily stored in suitable storage media such as e.g. batteries, capacitors, disk flywheels, etc. and supplied to the system again from the energy accumulator 33 as necessary. Overall, a propulsion system of this kind permits CO2-free powering of the aircraft 11.

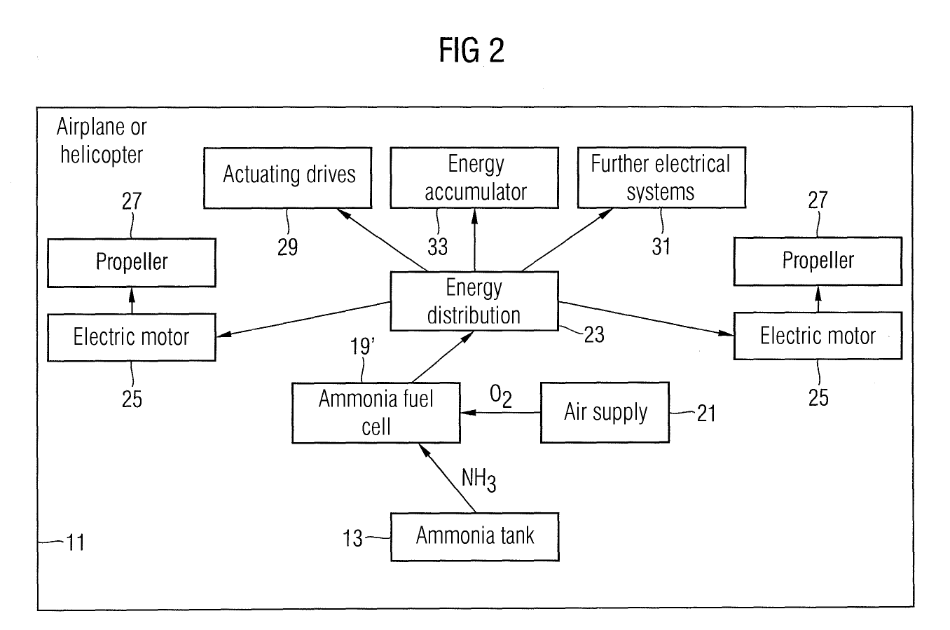

In another embodiment, shown in FIG. 2, the fuel cell 19′ is embodied in such a way that it can use the ammonia directly as fuel. Examples of fuel cells of this type are solid oxide fuel cells (SOFCs) or protonic ceramic fuel cells (PCFCs), molten carbonate fuel cells (MCFCs), intermediate temperature direct ammonia fuel cells (IT-DAFCs), though suitable fuel cells are not limited to these.

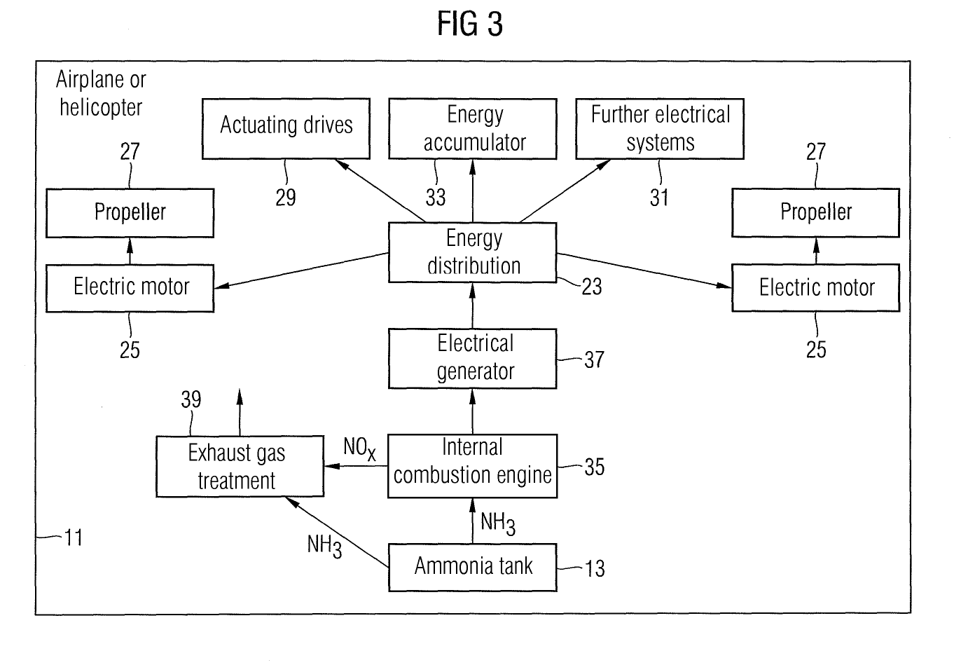

In another embodiment, shown in FIG. 3, no fuel cell is used. An internal combustion engine 35 powered by ammonia is substituted in its place. Said internal combustion engine can for example be an engine operating in accordance with the diesel cycle, what is referred to as an HCCI engine (HCCI standing for “homogenous charge compression ignition”) or similar, or else it can be a gas turbine. The internal combustion engine 35 drives an electric generator 37 by means of which electrical energy is generated. The generators can be equipped with superconducting magnets.

The exhaust gases of the internal combustion engine 35 contain nitrogen, water and nitrogen oxides. The nitrogen oxides may be converted into nitrogen in a cleaning stage 39 by means of a reaction with ammonia with the aid of a zeolite as catalyst, e.g. in accordance with the reaction equations:

4 NO+4 NH₃+O₂->4 N₂+6 H₂O and

6 NO₂+8 NH₃->7 N₂+12 H₂O.

The ammonia required for the reaction can be provided from the fuel tank 13.

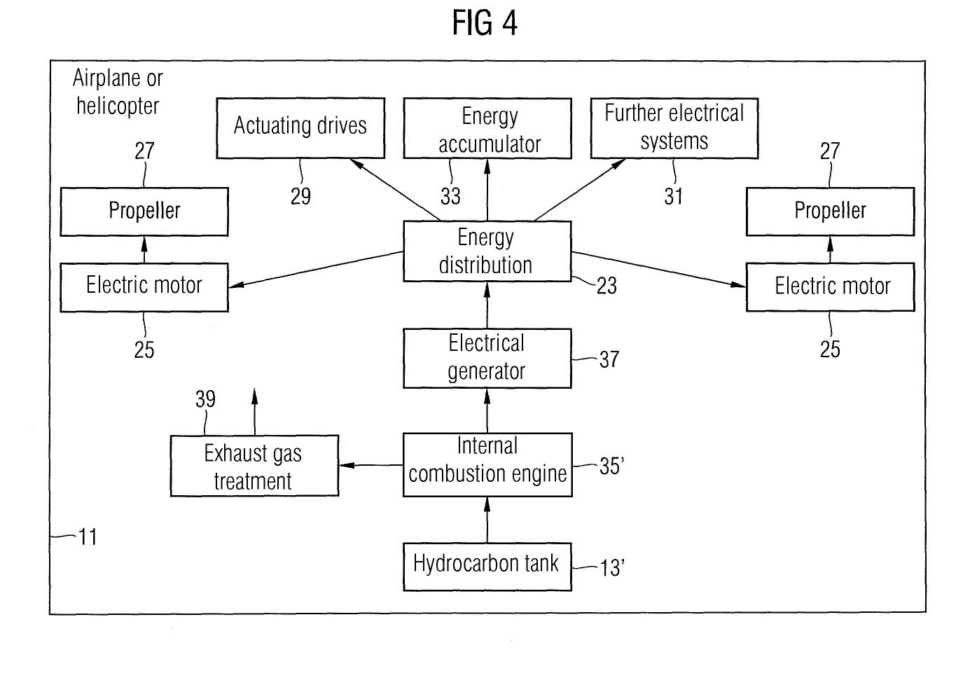

FIG. 4 shows an aircraft 11 which is similar in design to the airplane shown in FIG. 3. It differs from the airplane shown in FIG. 3 in that now, instead of ammonia, a hydrocarbon-based fuel, such as e.g. diesel, kerosene or gasoline, which is stored in a tank 13′, is used as fuel for the internal combustion engine 35′ by means of which the electric generator 37 is driven and the electrical energy generated.

FIG. 5 shows a cooling device 46 for cooling the tank 13 in a schematic view. For clarity of illustration reasons, other components such as e.g. the ammonia separator and the molecular sieve, etc. are not depicted. The atmosphere can be used, at least temporarily, i.e. for example while the aircraft 11 is in the air, for cooling the tank 13 or, more specifically, the ammonia contained in the tank 13. In this case use is made of the fact that the temperature falls as the height above sea level increases, so that when the aircraft 11 reaches a certain altitude the prevailing outside temperature is sufficiently low to cool down the ammonia contained in the tank 13 to a temperature at which the ammonia is present in liquid form.

For this purpose the tank 13 is connected to the atmosphere 1 by heat-conducting means in such a way that heat from the tank 13 is discharged to the atmosphere 1. Toward that end the tank 13 can be connected to the outside wall 40 of the aircraft 11 by way of a thermal coupling 41 such that the heat that is to be dissipated from the tank 13 is discharged to the atmosphere 1 via the outside wall 40.

The thermal coupling 41 is realized for example by way of heat conduction, e.g. by means of thermal bridges in the form of cooling plates or similar (not shown in detail) which connect the tank 13 directly or indirectly to the outside wall 40 of the aircraft 11. Alternatively or in addition the thermal coupling 41 between tank 13 and outside wall 40 can be based on the heat convection effect, with the corresponding cooling medium, e.g. air or water, conducting the heat absorbed by the tank 13 to the outside wall 40 of the aircraft.

It is of course possible to combine different approaches for liquefying the ammonia. In addition to using the atmosphere, a conventional cooling arrangement 42 can be provided which is deployed in particular when the outside temperature is too high, i.e. for example during periods when the aircraft 11 is on the ground. In addition or alternatively a device 43 can also be provided which puts the tank 13, or more specifically the ammonia contained therein, under pressure.

The tank 13 can therefore be cooled by means of a conventional cooling arrangement 42 during periods in which the outside temperature is higher than a specific threshold value. The conventional cooling arrangement 42 can be dispensed with during periods in which the outside temperature lies below the threshold value. The threshold value is determined on the one hand on the basis of the boiling point of ammonia and on the other hand as a function of the type and mode of functioning of the thermal coupling 41 between tank 13 and outside wall 40 of the aircraft 11. With a less efficient thermal coupling 41 the chosen threshold value temperature will be commensurately lower. In a temperature range around the threshold value it is conceivable to use both the conventional cooling arrangement 42 and the above-described atmospheric cooling.

Toward that end a controller 44 is provided which is connected to an outside temperature sensor 45 which measures the temperature of the atmosphere 1 in the vicinity of the aircraft 11. The suitable method of cooling is chosen with the aid of the controller 44 in accordance with the measured temperature. For example, if the outside temperature is too high, the controller 44 can interrupt the thermal coupling 41 and put the conventional cooling arrangement 42 into operation. In addition or alternatively the controller 44 can also control the pressure generator 43 as a function of the outside temperature and/or the aggregation state of the ammonia in the tank 13. For example, the pressure generator 43 can be put into operation when the ammonia in the tank transitions into a gaseous state.

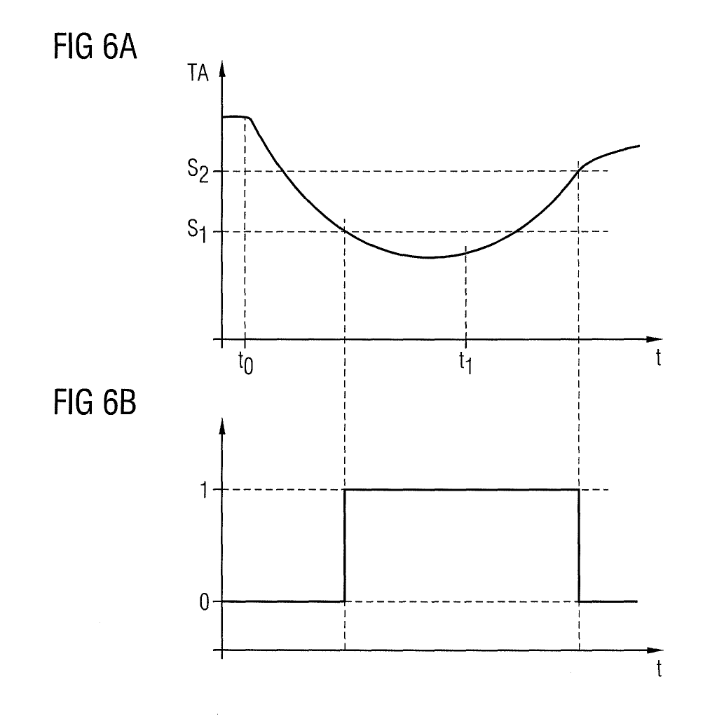

The response of the controller 44 as a function of the outside temperature TA is illustrated in FIG. 6. The diagram in FIG. 6A shows a characteristic curve of the outside temperature TA varying with time t. Such a characteristic curve can be produced for example when the aircraft 11 takes off at a time instant t0 and gains altitude, with the result that the outside temperature drops. As of a time instant t1, the aircraft starts to lose altitude again, with the result that the outside temperature TA rises again.

The controller 44 opens and closes the thermal coupling 41 as a function of the outside temperature. Toward that end the outside temperature TA is compared with two threshold values S1, S2, where S2>S1 applies. FIG. 6B shows the status of the thermal coupling 41 as a function of time and in synchronism with the diagram shown in FIG. 6A. As soon as the outside temperature TA lies below the threshold value S1, the thermal coupling 41 is established between tank 13 and atmosphere 1, i.e. the atmospheric cooling is active. This is symbolized in FIG. 6B by the status “1”. However, as soon as the outside temperature TA rises above the threshold value S2 again, where S2>S1, the thermal coupling 41 is opened, which is to say interrupted, again, with the result that the atmosphere no longer contributes toward cooling the tank 13. This is symbolized in FIG. 6B by the status “0”. The threshold values S1, S2 can, of course, also have the same value, i.e. S1=S2.

The use of atmospheric cooling may provide that, in particular while the aircraft is flying at an appropriate altitude, a comparatively small amount of energy, or in the ideal case even no energy at all, is consumed in order to cool the ammonia or maintain it in the liquid state. Since the proportion of energy required to be consumed for cooling purposes is quite high, a significant increase in efficiency can be achieved by means of this measure.

### LIST OF REFERENCE SIGNS

1 Atmosphere

11 Aircraft

13 Ammonia tank

13′ Hydrocarbon tank

15 Ammonia separator

17 Molecular sieve

19 Hydrogen fuel cell

19′ Ammonia fuel cell

21 Air supply

23 Energy distribution

25 Electric motor

27 Power plant

29 Actuating drive

31 Further electrical system

33 Energy accumulator

35, 35′ Internal combustion engine

37 Electric generator

39 Exhaust gas treatment

40 Outside wall

41 Thermal coupling

42 Conventional cooling arrangement

43 Pressure generator

44 Controller

45 Outside temperature sensor

46 Cooling device

What is claimed is:

1. An electrically driven aircraft, comprising:
a tank for NH₃ for providing NH₃,
an energy source that generates electrical energy by using and converting NH₃,
an electrically driven propulsion system that is responsible for powering the aircraft, and
an energy distribution system which that provides the generated electrical energy to the propulsion system.

2. The electrically driven aircraft of claim 1, further comprising at least one further electrical system that obtains the electrical energy necessary for its operation via the energy distribution system from the electrical energy generated by the energy source.

3. The electrically driven aircraft of claim 1, wherein the aircraft additionally includes a storage device which is connected to the energy distribution system and serves for storing surplus electrical energy that has been generated.

4. The electrically driven aircraft of claim 1, wherein the energy source, which generates electrical energy by using and converting NH₃, is an NH₃-powered fuel cell system.

5. The electrically driven aircraft of claim 4, wherein the NH₃-powered fuel cell system includes an NH₃ fuel cell which generates electrical energy by directly using NH₃ as fuel.

6. The electrically driven aircraft of claim 4, wherein the NH₃-powered fuel cell system includes an ammonia separator for generating H₂ and N₂ and, connected downstream thereof, a hydrogen fuel cell which generates electrical energy by using H₂ as fuel.

7. The electrically driven aircraft of claim 6, wherein a molecular sieve is disposed between the ammonia separator and the hydrogen fuel cell for the purpose of removing contaminants due to residual NH₃ from the H₂ supplied to the hydrogen fuel cell.

8. The electrically driven aircraft of claim 1, wherein the energy source comprises an internal combustion engine fed from the NH₃ tank and an electric generator driven by the internal combustion engine.

9. The electrically driven aircraft of claim 8, comprising an exhaust gas treatment device that cleans the exhaust gas produced by the internal combustion engine of nitrogen oxides before the exhaust gas is discharged into the atmosphere.

10. The electrically driven aircraft of claim 1, wherein the aircraft is embodied as an airplane or as a helicopter.

11. The electrically driven aircraft of claim 1, wherein the tank is connected to the atmosphere by way of a thermal coupling for the purpose of cooling the tank and the NH₃ contained in the tank, wherein heat from the tank can be discharged to the atmosphere by way of the thermal coupling.

12. The electrically driven aircraft of claim 11, comprising a controller configured to thermally couple the tank to the atmosphere if the atmospheric temperature in the vicinity of the aircraft falls below a specific threshold value.

13. The electrically driven aircraft of claim 12, comprising a controller configured to interrupt the thermal coupling if the atmospheric temperature in the vicinity of the aircraft rises above a specific threshold value.
